(19) United States
(12) Patent Application Publication
(10) Pub. No.: US 2009/0302221 A1
(43) Pub. Date: Dec. 10, 2009

(54) APPARATUS AND METHOD FOR OPTICALLY DETERMINING THE PRESENCE OF CARBON DIOXIDE

(76) Inventors: Emmanuel Tavernier, Paris (FR); Eric Donzier, Bercheres sur Vesgre (FR); Fadhel Rezgui, Chatillon (FR); Philippe Salamitou, Paris (FR)

Correspondence Address: SCHLUMBERGER OILFIELD SERVICES, 200 GILLINGHAM LANE, MD 200-9, SUGAR LAND, TX, 77478, US

(21) Appl. No.: 12/441,611

(22) PCT Filed: Aug. 24, 2007
(86) PCT No.: PCT/EP2007/007602

§ 371 Date: Jul. 23, 2009

(30) Foreign Application Priority Data
Sep. 20, 2006 (EP) 06291479.1

(51) Int. Cl. G01N 21/55

(52) U.S. Cl. 250/338.5; 250/341.2

(57) ABSTRACT

Apparatus for optically determining the presence of carbon dioxide within a fluid, said apparatus comprising:—a light emitting source, an optical sensing probe in contact with the fluid to analyze; optical light transmitting means in order to convey the light emitted from the light emitting source to the optical sensing probe and the light reflected by the optical sensing probe to means to discriminate between wavelengths of light beams reflected by the optical sensing probe;—means to convert wavelengths discriminated light beams into measurement data indicating presence of carbon dioxide within the fluid, wherein the optical sensing probe comprises a tip working as attenuated total reflection (ATR) absorber within the infrared wavelength.

### FIELD OF THE INVENTION

The apparatus and method according to the invention relates to the optical determination of the presence of carbon dioxide within a fluid. More precisely, the apparatus and method according to the invention relates to the determination of carbon dioxide partial pressure within the gas phase of the wellbore effluents.

### DESCRIPTION OF THE PRIOR ART

Carbon dioxide is naturally present in gas wells as well as in gas phase of oil wells effluents. Its concentration varies between 0 and 100%. For economic reasons, it is important to be able of determining this concentration in order to assess the commercial value of a reservoir. In case the CO2 concentration is high, the value of the reservoir will significantly decrease. Furthermore a high CO2 concentration will have strong impact on maintenance of the well equipments—especially the ones intervening in the completion part of the well—due to high corrosives properties of this gas.

It is already known to use absorption spectroscopy within ultra-violet bands, visible and infrared bands when analyzing wellbore effluents quantitatively as well as qualitatively.

The OFA, Optical Fluid Analyser system, in the Schlumberger commercially available MDT, Modular Formation Dynamics Tester, tool has provided since its introduction in 1993 a qualitative measure of fluid samples collected in the wellbore via the MDT tool. The OFA analyser system subjects formation fluids to illumination within the visible and near infrared domains. Within these specific wavelengths, it is not possible to evaluate the CO2 concentration because other wellbore components absorb light within the same wavelength.

It is known in the art to use differential spectroscopy within the infrared, around 4.3 μm for measuring the CO2 concentration, especially within environmental surveillance applications. Within this wavelength, carbon dioxide presents an important and characteristic absorption band. This absorption band does not interfere with the absorption bands of other wellbore components.

The typical wavelength at which the infrared signal can penetrate in the sample before being completely attenuated depends on CO2 density and concentration. Regarding the usual conditions within hydrocarbon wells (pressure up to 20000 Psi, temperature up to 200° C. or more, CO2 concentration from 2% to 50%), it requires an optical path length of the order of microns to measure carbon dioxide via differential absorption at 4.3 μm. This optical path length is too small for using the OFA system as described above wherein the optical path length is of the order of millimeters.

The “Attenuated Total Reflexion” (ATR) principle is well known as being well adapted for spectroscopy within absorbing materials. This technique allows spectroscopy measurements using optical path lengths of the order of micron. Within the ATR principle, an incident beam is emitted towards a window behind which is the fluid to analyze. The incidence angle is such that a total reflexion occurs. An evanescent wave is then transmitted in the medium to analyze and is absorbed within the absorption wavelengths of said medium. This absorption is detectable on the spectrum of the reflected wave.

The known ATR optical sensors comprise flat windows. This specificity generates a significant problem when desiring to use said sensors within the context of wellbore fluids. Actually, due to the effluent different phases (oil, water and gas), the sensor flat window is rapidly polluted, which significantly impacts the measurement accuracy.

It is thus an object of the invention to overcome the various problems and limitations given within the techniques known from the prior art in order to offer reliable and accurate method and apparatus for measuring presence of carbon dioxide within well effluents. The method and apparatus of the invention will then be useable in a huge number of applications among—and non restrictively—within samples taken from the formation, within the effluent flow during production (production logging operation) or in surface testing facilities. The apparatus and method according to the invention will also be applicable to various types of fluids, dependent on nature of wells (gas, hydrocarbon, water).

### SUMMARY OF THE INVENTION

According to the invention, it is proposed an apparatus for optically determining the presence of carbon dioxide within a fluid, said apparatus comprising:
a light emitting source,
an optical sensing probe in contact with the fluid to analyze;
optical light transmitting means in order to convey the light emitted from the light emitting source to the optical sensing probe and the light reflected by the optical sensing probe to means to discriminate between wavelengths of light beams reflected by the optical sensing probe;
means to convert wavelengths discriminated light beams into measurement data indicating presence of carbon dioxide within the fluid,
   wherein the optical sensing probe comprises a tip working as attenuated total reflection (ATR) absorber within the infrared wavelength.

This apparatus advantageously allows detection of CO2 presence within abrasive and multiphase fluids since the optical principle (ATR) put in place is particularly efficient for CO2 detection and usage of a sensing probe with a tip allows a surface capillary drainage. This drainage ensures that the sensing probe remains clean even when immersed within well effluents, which allows reliable optical measurements.

In an advantageous embodiment, the tip of the optical sensing probe comprises a conical shape having an angle partial to its axis such that a total reflection of the light emitted from the light emitting source occurs.

Advantageously, the angle of the conical tip of the sensing probe is approximately 90° and the optical sensing probe is made out of sapphire.

Advantageously, the optical transmitting means comprise a first wave guide conveying the light from the light emitting source to an optical coupler; the optical coupler conveying the light emitted to and reflected from the optical sensing probe; and a second wave guide conveying the light reflected by the optical sensing probe to the means to discriminate between wavelengths of light beams. In a preferred embodiment, the wave guides are made out of sapphire rods.

In an advantageous embodiment, the optical coupler is a multimode coupler comprising extremities of the first and second wave guides, said extremities being beveled and glued together.

It is also an object of the present invention to propose a method for optically determining the presence of carbon dioxide within a fluid, the method comprises:
injecting an incident light beam into an optical sensing probe in contact with the fluid to analyze,
sending the light beam reflected by the optical sensor probe to discriminating means;
discriminating between wavelengths of reflected light beams such the band of light (F3) corresponding to the carbon dioxide absorption wavelength is isolated from other bands (F4);
determining the ratio between intensity of light (F3) band corresponding to the carbon dioxide absorption wavelength and intensity of light (F4) bands corresponding to non-carbon dioxide wavelengths;
using the ratio to indicate presence of carbon dioxide within the fluid,
   wherein the incident light beam is an infrared light beam and the optical sensor probe is designed such that an attenuated total reflexion (ATR) of the incident beam occurs at a probe tip.

Advantageously, the presence of carbon dioxide is given by the partial carbon dioxide pressure according to the relation:

Pᵣₑₗ CO2=invf (F3/F4)

wherein F3 is the intensity of light band corresponding to the carbon dioxide absorption wavelength and F4 is the intensity of light bands corresponding to non-carbon dioxide absorption wavelengths.

### BRIEF DESCRIPTION OF THE DRAWINGS

Various embodiments of the invention are described below by way of example with reference to the accompanying drawings, in which:

FIG. 1 schematically represents an apparatus according to the invention;

FIG. 2 schematically represents light wave guides arrangements according to one embodiment of the invention

FIG. 3 schematically represents means to represents and convert reflected bands of light according to an embodiment of the invention;

FIG. 4 schematically represents a second embodiment of light wave guides arrangement according to the invention.

FIG. 5 schematically represents an example of a sensing probe according to the invention;

### DESCRIPTION OF THE PREFERRED EMBODIMENTS

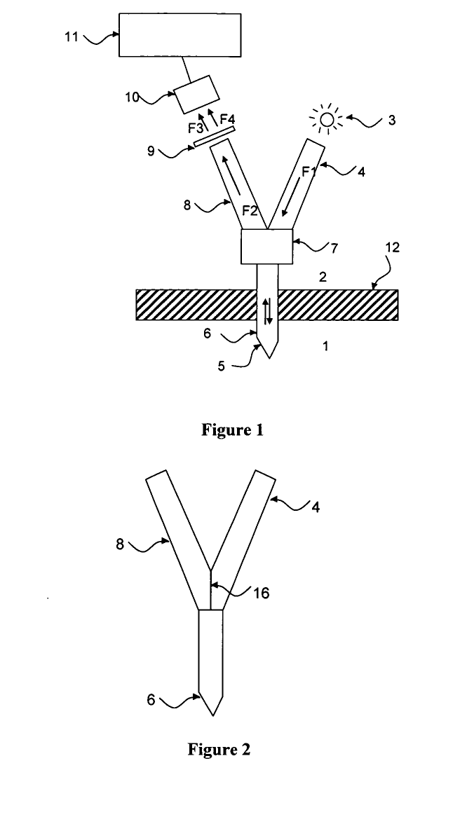

FIG. 1 represents schematically an apparatus according to the invention. An optical sensor probe 6 is in contact with a medium 1 to analyze. A sealed pressure barrier 12 isolates the sensor probe 6 from the rest of the optical apparatus 2. Therefore, other sensitive optical and electronic pars of the apparatus are not exposed to same rough conditions that the sensing probe faces. The pressure barrier 12 can be made out of various ways among which are: brazing of the sensing probe 6 within a metallic barrier 12 or gluing said probe into the barrier 12 or even the two of these previous methods.

An infrared light 3 source transmits an infrared light beam F1 within a first wave guide 4. As a matter of example, the infrared light source can be a blackbody source: an incandescent filament light with bulb transparent to infrared light or an infrared light.

The light beam F1 is conducted towards the sensing probe 6 by a coupler 7. In a preferred example, the coupler is a multimode one and, as represented on FIG. 2, comprises extremities of the waves guides 4 and 8 that have been beveled and glued together at an interface 16.

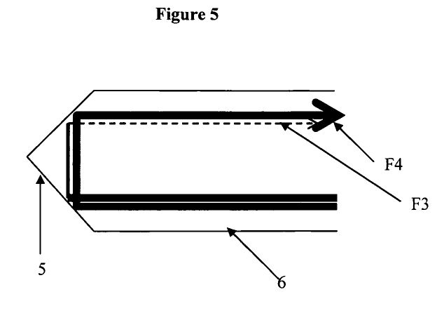

The sensing probe comprises a tip 5 which is designed such that the emitted infrared light beam is reflected according to a total reflexion. Advantageously, as schematically represented on FIG. 5, the sensing probe 6 is made out of sapphire and the tip 5 is cone shaped with an angle relative to axis of the cone of approximately 45° (cone shape with angle of 90°).

The reflected light beam then travels back from the tip 5 to the sensor probe 6. The coupler 7 then guides a light beam F2, which is a part of the reflected light beam, towards a second wave guide 8. Advantageously, the first and second wave guides 4 and 8 are made out of sapphire rods with a diameter of approximately 1.5 mm.

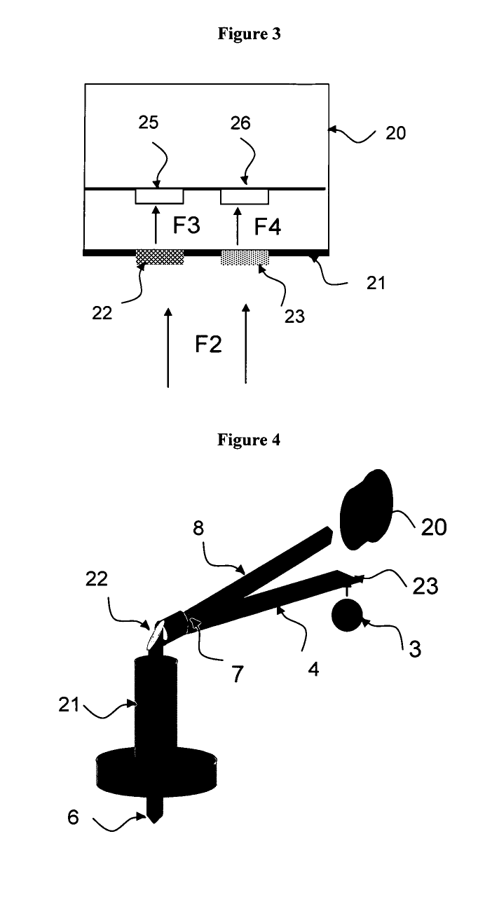

Discriminating means 9 then decomposes the infrared light beam F2 in various wavelengths. Part of these wavelengths F3 is in the carbon dioxide absorption band whether second part F4 of these wavelengths is out of the CO2 absorption band. As represented on FIG. 3, the discriminating means 9 may comprise two filters 22 and 23 placed side by side on a baffle 21. These filters respectively separate F3 light beam from the F4 light beam in the light beam F2.

Once isolated F3 light beam from F4 light beam, converting means 10 convert F3 and F4 into electrical signals. As represented on FIG. 3, two pyroelectric detectors 25 and 26 may constitute the converting means 10. The detectors 25 and 26 are placed side by side in front of filters 22 and 23 respectively. In this way, detector 25 is only exposed to light beam F3 whereas detector 26 in only exposed to light beam F4. The detectors 25 and 26 as well as the filters 22 and 23 can be placed in the same housing 20.

These electrical signals are turned into digital signals and interpreted by a controller 11.

The ratio between the intensity of light beams F3 and F4 is a function f of the carbon dioxide concentration in the medium 1 to analyze. The partial carbon dioxide pressure, Pₚₐᵣ CO2, is given by the inverse of said function f:

Pₚₐᵣ CO2=invf (F3/F4).

The apparatus and method according to the invention can be implemented in any tool wherein the tip 5 of the sensing probe 6 can being contact with the fluid to analyze.

As an example, the apparatus according to the invention can be placed within the flowline of the commercially available MDT, Modular Formation Dynamics Tester, tool. In this embodiment, the whole apparatus is located in the tool body such that the tip of the sensing probe is in contact with the formation sample taken by the MDT while the other part of the apparatus are sealed from the sample fluids.

As represented on FIG. 4, it is possible to collapse optical paths 4 and 8 so that the apparatus according to the invention is made smaller and robust. To this end, the extremity 42, opposed to the tip 5 of the sensing probe 6, and the extremity 43, closed to the infrared light 3, of the wave guide 4 are beveled with a 45° angle so that the optical path can be bent to 90°. In this example, the infrared light 3 source inject into the wave guide 4 an infrared light beam via the beveled end 43. The wave guides 4 and 8 are perpendicular to the axis of the sensing probe 6 and optically linked together via the beveled extremity 42 of said probe.

1. Apparatus for optically determining the presence of carbon dioxide within a fluid, said apparatus comprising:
a light emitting source,
an optical sensing probe in contact with the fluid to analyze;
optical light transmitting means in order to convey the light emitted from the light emitting source to the optical sensing probe and the light reflected by the optical sensing probe to means to discriminate between wavelengths of light beams reflected by the optical sensing probe;
means to convert wavelengths discriminated light beams into measurement data indicating presence of carbon dioxide within the fluid,
wherein the optical sensing probe comprises a tip working as attenuated total reflection (ATR) absorber within the infrared wavelength.

2. Apparatus according to claim 1, wherein the tip of the optical sensing probe comprises a conical shape having an angle partial to its axis such that a total reflection of the light emitted from the light emitting source occurs.

3. Apparatus according to claim 1, wherein the angle of the conical tip of the sensing probe is approximately 90°.

4. Apparatus according to claim 1, wherein the optical sensing probe is made out of sapphire.

5. Apparatus according to claim 1, wherein the light emitting source is a blackbody source emitting in the an infrared light.

6. Apparatus according to any preceding claims, wherein the optical transmitting means comprise:
a first wave guide conveying the light from the light emitting source to an optical coupler;
the optical coupler conveying the light emitted to and reflected from the optical sensing probe; and
a second wave guide conveying the light reflected by the optical sensing probe to the means to discriminate between wavelengths of light beams.

7. Apparatus according to claim 6, wherein the wave guides are made out of sapphire rods.

8. Apparatus according to claim 6 wherein the optical coupler is a multimode coupler comprising extremities of the first and second wave guides, said extremities being beveled and glued together.

9. A method for optically determining the presence of carbon dioxide within a fluid, said method comprises:
injecting an incident light beam into an optical sensing probe in contact with the fluid to analyze,
sending the light beam reflected by the optical sensor probe to discriminating means;
discriminating between wavelengths of reflected light beams such the band of light (F3) corresponding to the carbon dioxide absorption wavelength is isolated from other bands (F4);
determining the ratio between intensity of light (F3) band corresponding to the carbon dioxide absorption wavelength and intensity of light (F4) bands corresponding to non-carbon dioxide wavelengths;
using the ratio to indicate the presence of carbon dioxide within the fluid,
wherein the incident light beam is an infrared light beam and the optical sensor probe is designed such that an attenuated total reflexion (ATR) of the incident beam occurs at the probe tip.

10. A method according to claim 9, wherein the presence of the carbon dioxide is given by the partial carbon dioxide pressure according to the relation:
Pᵣₑₗ CO2=invf (F3/F4)
where in F3 is the intensity of light band corresponding to the carbon dioxide absorption wavelength and F4 is the intensity of light bands corresponding to non-carbon dioxide absorption wavelengths.
